(19) United States
(12) Patent Application Publication
(10) Pub. No.: US 2025/0121799 A1
(43) Pub. Date: Apr. 17, 2025

(54) WIPER CONTROL APPARATUS AND WIPER APPARATUS FOR VEHICLE

(71) Applicant: TOYOTA JIDOSHA KABUSHIKI KAISHA, Aichi-ken (JP)

(72) Inventor: Tatsuya SHIMIZU, Okazaki-shi (JP)

(21) Appl. No.: 18/888,183

(22) Filed: Sep. 18, 2024

(30) Foreign Application Priority Data
Oct. 11, 2023 (JP) 2023-176176

(51) Int. Cl. B60S 1/08; B60R 21/38

(52) U.S. Cl. CPC B60S 1/0818; B60R 21/38

(57) ABSTRACT

A wiper apparatus for a vehicle reciprocally moves a wiper between a lower reverse position and an upper reverse position by reciprocally rotating a rotational shaft of a wiper motor. A wiper control apparatus for the wiper apparatus includes a processor that controls operation of the wiper. The processor switches operation of the wiper depending on a moving direction of the wiper when the processor receives a notification of prediction that the vehicle will collide with a person while the wiper is operating.

### CROSS-REFERENCE TO RELATED APPLICATION

This application claims priority to Japanese Patent Application No. 2023-176176 filed on Oct. 11, 2023, incorporated herein by reference in its entirety.

### BACKGROUND

### 1. Technical Field

The present disclosure relates to a wiper control apparatus and a wiper apparatus for a vehicle.

### 2. Description of Related Art

In Japanese Unexamined Patent Application Publication No. 2005-319887, a technology that releases a control state of a wiper when it is determined that there is a possibility of a collision with a pedestrian existing ahead of a vehicle in a traveling direction at the time of a wiper operation, and returns the wiper to an initial position (stopping position) by a high-speed operation (Hi) with use of a wiper control relay for Hi is described (for example, see paragraph [0034]).

In the technology described in JP 2005-319887 A, there may be cases in which the wiper cannot be moved to the stopping position in time within an amount of time it takes until an actual collision with the pedestrian occurs even when the wiper is switched to the high-speed operation (Hi) depending on the position and the moving direction of the wiper at the time of prediction of a collision with a pedestrian. In this case, there is a risk that the pedestrian that has collided with the vehicle and has been thrown onto the windshield glass comes into contact with the wiper.

### SUMMARY

The present disclosure provides a wiper control apparatus and a wiper apparatus for a vehicle which promptly move a wiper to a predetermined stopping position when it is predicted that the vehicle will collide with a person.

One aspect of the present disclosure is a wiper control apparatus for a wiper apparatus of a vehicle. The wiper apparatus reciprocally moves a wiper between a lower reverse position and an upper reverse position by reciprocally rotating a rotational shaft of a wiper motor. The wiper control apparatus includes a processor configured to control operation of the wiper. The processor is configured to switch operation of the wiper depending on a moving direction of the wiper when the processor receives a notification of prediction that the vehicle will collide with a person while the wiper is operating.

The wiper apparatus in the present disclosure has a configuration of reciprocally moving the wiper by reciprocally rotating the rotational shaft of the wiper motor, and hence the operation of the wiper apparatus (for example, the moving direction and the moving speed of the wiper) can be switched at a freely-selected timing. On the basis of the above, in the present aspect, the operation of the wiper apparatus is switched depending on the moving direction of the wiper when it is predicted that the own vehicle will collide with a person. As a result, when it is predicted that the vehicle will collide with a person, the wiper can be promptly moved to a predetermined stopping position. The predetermined stopping position may be a lower reverse position or may be a position below the lower reverse position. The “person” in the present disclosure may include a pedestrian, a person riding a two-wheeled vehicle such as a bicycle, and the like.

The processor may be configured to immediately switch the moving direction of the wiper to a close direction when the processor receives the notification and the moving direction of the wiper is an open direction.

As described above, the wiper apparatus in the present disclosure has a configuration of reciprocally moving the wiper by reciprocally rotating the rotational shaft of the wiper motor. Therefore, the moving direction of the wiper can be switched by reverse rotation of the rotational shaft of the wiper motor even at a timing at which the moving direction of the wiper is the open direction (a direction heading toward the upper reverse position from the lower reverse position) and the wiper is positioned between the lower reverse position and the upper reverse position. On the basis of the above, the moving direction of the wiper is immediately switched to the close direction (a direction heading toward the lower reverse position from the upper reverse position) when the moving direction of the wiper is the open direction when it is predicted that the own vehicle will collide with a person. As a result, the wiper can be promptly moved to a predetermined stopping position.

The processor may be configured to switch a moving speed of the wiper to one of speeds. The processor may be configured to switch the moving speed of the wiper to a fastest speed out of the speeds when the processor receives the notification.

The moving speed of the wiper is switched to the fastest speed out of the plurality of speeds when it is predicted that the own vehicle will collide with a person. As a result, the amount of time it takes until the wiper reaches the predetermined stopping position can be shortened as compared to a case in which the moving speed of the wiper is not switched.

The processor may be configured to switch a moving speed of the wiper to one of speeds. The processor may be configured to switch the moving speed of the wiper to a speed that is even faster than the fastest speed out of the speeds when the processor receives the notification.

The moving speed of the wiper is switched to a speed that is even faster than the fastest speed out of the plurality of speeds when it is predicted that the own vehicle will collide with a person. As a result, the amount of time it takes until the wiper reaches the predetermined stopping position can be shortened even more as compared to a case in which the moving speed of the wiper is switched to the fastest speed out of the plurality of speeds. The setting of the moving speed of the wiper to be even faster than the fastest speed out of the plurality of speeds can be realized by increasing the current supplied to the wiper motor than that at the fastest speed, for example.

The processor may be configured to operate a pop-up hood apparatus that lifts an end portion of a hood of the vehicle when the processor receives the notification.

When it is predicted that the own vehicle will collide with a person, a pop-up hood apparatus that lifts a rear end portion of a hood of the own vehicle is operated. As a result, the area in which the wiper is covered by the rear end portion of the hood is expanded, and the degree by which the person sustains an injury due to a contact with the wiper can be decreased.

Another aspect of the present disclosure is a wiper apparatus for a vehicle. The wiper apparatus includes a wiper, a wiper motor having a rotational shaft, and a processor configured to control operation of the wiper. The wiper motor is configured to reciprocally rotate the rotational shaft to reciprocally move the wiper between a lower reverse position and an upper reverse position. The processor is configured to switch operation of the wiper depending on a moving direction of the wiper when the processor receives a notification of prediction that the vehicle will collide with a person while the wiper is operating.

The present disclosure has an effect of being able to of promptly move the wiper to the predetermined stopping position when it is predicted that the vehicle will collide with the person.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a schematic view showing a wiper apparatus and a wiper control apparatus according to a first embodiment;

FIG. 2 is a functional block diagram of a wiper control ECU;

FIG. 3 is a flowchart showing wiper control processing according to the first embodiment;

FIG. 4 is a flowchart showing wiper control processing according to a second embodiment;

FIG. 5 is a schematic view showing a wiper apparatus and a wiper control apparatus according to a third embodiment;

FIG. 6 is a flowchart showing wiper control processing according to the third embodiment;

FIG. 7 is a perspective view showing a state in which a pop-up hood apparatus is operated in the third embodiment; and

FIG. 8 is a schematic view showing another configuration example of a wiper apparatus.

### DETAILED DESCRIPTION OF EMBODIMENTS

One example of embodiments of the present disclosure is described in detail below with reference to the drawings.

### First Embodiment

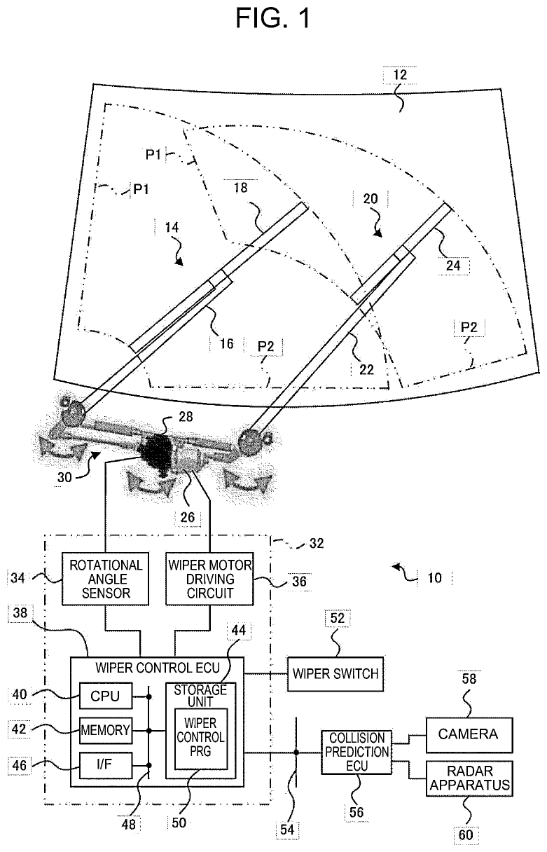

As shown in FIG. 1, a wiper apparatus 10 according to a first embodiment is an apparatus that wipes windshield glass 12 provided in a vehicle such as a passenger car, for example, and includes a pair of wipers 14, 20, a wiper motor 26, a link mechanism 30, and a wiper control apparatus 32. The wiper control apparatus 32 is one example of a vehicle wiper control apparatus according to the present disclosure.

The wiper 14 includes a wiper arm 16 having a proximal end portion fixed to a pivot axis (not shown), and a wiper blade 18 joined to a distal end portion of the wiper arm 16. The wiper 20 includes a wiper arm 22 having a proximal end portion fixed to a pivot axis (not shown), and a wiper blade 24 joined to a distal end portion of the wiper arm 22. When the wiper arms 16, 22 of the wipers 14, 20 are pivotally moved about the pivot axes, the wiper blades 18, 24 reciprocally move on the windshield glass 12. The wiper blades 18, 24 wipe the windshield glass 12.

The wiper motor 26 has a rotational shaft on which a gear mechanism 28 is mounted. The link mechanism 30 is provided between an output shaft of the gear mechanism 28 and the pivot axes of the wiper arms 16, 22. In the wiper apparatus 10, when a rotational shaft of the wiper motor 26 is reciprocally rotated in a predetermined rotational angle range, the rotational force of the rotational shaft of the wiper motor 26 is decelerated by the gear mechanism 28 and is transmitted to the wiper arms 16, 22 via the link mechanism 30. As a result, the wiper arms 16, 22 are pivotally moved in a reciprocal manner, and the wiper blades 18, 24 reciprocally move between lower reverse positions P2 and upper reverse positions P1 on the windshield glass 12.

The wiper control apparatus 32 is connected to the wiper motor 26, and includes a rotational angle sensor 34, a wiper motor driving circuit 36, and a wiper control electronic control unit (ECU) 38. 25

The rotational angle sensor 34 is provided in the gear mechanism 28, magnetically detects the rotation of the output shaft of the gear mechanism 28, and outputs a detection signal to the wiper control ECU 38. The wiper control ECU 38 detects the positions of the wiper blades 18, 24 and the operation direction of the wipers 14, 20 on the 30 windshield glass 12 by calculating the rotational angle of the output shaft of the gear mechanism 28 on the basis of the detection signal input from the rotational angle sensor 34.

The wiper motor driving circuit 36 includes a plurality of switching elements capable of turning energization to a coil of the wiper motor 26 on and off and capable of switching the orientation of the current that flows through the coil of the wiper motor 26 at the time of energization. One example of the plurality of switching elements is four field effect transistors (FETs) connected to form an H-bridge circuit. The wiper motor driving circuit 36 generates a driving signal that turns the plurality of switching elements on and off on the basis of a control signal input from the wiper control ECU 38. The wiper motor driving circuit 36 drives the wiper motor 26 by supplying the generated driving signal to the switching elements.

The wiper control ECU 38 includes a CPU 40, a memory 42, a non-volatile storage unit 44, and an interface (I/F) unit 46 that are connected to each other via an internal bus 48. A wiper switch 52 is connected to the wiper control ECU 38. The wiper switch 52 is capable of switching a contact point to a low-speed operation position (Lo) in which the wiper blades 18, 24 are moved at a low speed, a high-speed operation position (Hi) in which the wiper blades 18, 24 are moved at a high speed, an intermittent operation position (Int) in which the wiper blades 18, 24 are intermittently moved at a certain cycle, and a stopping position (Off).

When the contact point of the wiper switch 52 is the high-speed operation position, the wiper control ECU 38 outputs a control signal that drives the wiper motor 26 such that the wiper blades 18, 24 reciprocally wipe places between the upper reverse positions P1 and the lower reverse positions P2 at a high speed to the wiper motor driving circuit 36. When the contact point of the wiper switch 52 is the low-speed operation position, the wiper control ECU 38 outputs a control signal that drives the wiper motor 26 such that the wiper blades 18, 24 reciprocally wipe places between the upper reverse positions P1 and the lower reverse positions P2 at a low speed to the wiper motor driving circuit 36. When the contact point of the wiper switch 52 is the intermittent operation position, the wiper control ECU 38 outputs a control signal that drives the wiper motor 26 such that the wiper blades 18, 24 reciprocally wipe places between the upper reverse positions P1 and the lower reverse positions P2 at a low speed and stop at the lower reverse positions P2 for a predetermined amount of time to the wiper motor driving circuit 36.

In the present embodiment, the changing of the rotation speed of the rotational shaft of the wiper motor 26 is realized by driving the wiper motor 26 by pulse width modulation (PWM) control. In other words, the wiper control ECU 38 switches the control signal such that the duty ratio of the on and off of the switching elements of the wiper motor driving circuit 36 is switched between the case of a high-speed operation (Hi) and the case of a low-speed operation (Lo/Int). As a result, the rotation speed of the rotational shaft of the wiper motor 26 is switched as a result of the magnitude of the current that flows through the coil of the wiper motor 26 switching between the case of the high-speed operation (Hi) and the case of the low-speed operation (Lo/Int).

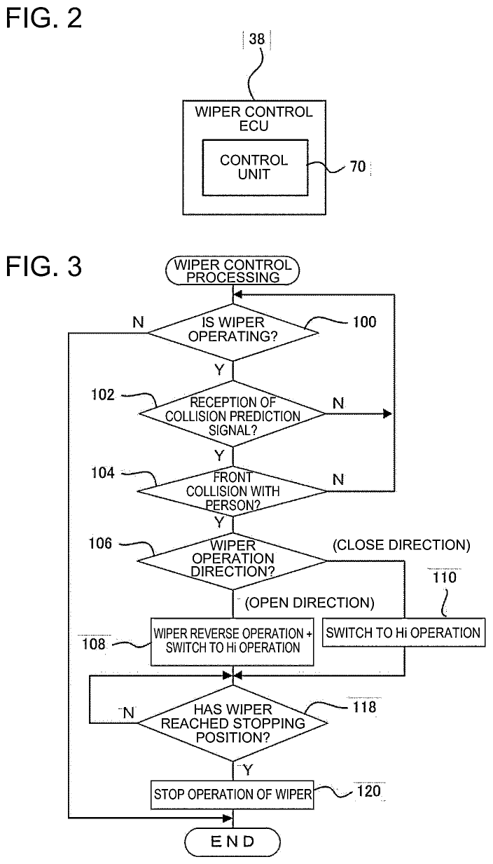

A wiper control program 50 is stored in the storage unit 44 of the wiper control ECU 38. The wiper control program 50 is read out from the storage unit 44 and is loaded into the memory 42. The wiper control program 50 loaded into the memory 42 is executed by the CPU 40. As a result, the wiper control ECU 38 functions as a control unit 70 shown in FIG. 2 and performs wiper control processing described later.

The control unit 70 switches the operation of the wiper apparatus 10 depending on the moving direction of the wipers 14, 20 when it is predicted that an own vehicle (a vehicle on which the wiper apparatus 10 is mounted) will collide with a person by a collision prediction ECU 56 described later during the operation of the wiper apparatus 10. In more detail, the control unit 70 immediately switches the moving direction of the wipers 14, 20 to a close direction when the moving direction of the wipers 14, 20 is an open direction when it is predicted that the own vehicle will collide with a person. The open direction is a direction heading toward the upper reverse positions P1 from the lower reverse positions P2, and the close direction is a direction heading toward the lower reverse positions P2 from the upper reverse positions P1. The control unit 70 switches the moving speed of the wipers 14, 20 to the fastest speed, that is, a high-speed operation (Hi) speed in the present first embodiment out of the plurality of speeds (Hi/Lo, Int) when it is predicted that the own vehicle will collide with a person by the collision prediction ECU 56.

The wiper control ECU 38 is connected to a system bus 54 of an in-vehicle system. A plurality of ECUs including the collision prediction ECU 56 is connected to the system bus 54 (ECUs other than the collision prediction ECU 56 are not shown in FIG. 1). A camera 58 that photographs the periphery of the own vehicle, and a radar apparatus 60 that detects relative positions and relative speeds of objects such as a pedestrian, a two-wheeled vehicle such as a bicycle, and other vehicles existing in the periphery of the own vehicle with respect to the own vehicle are connected to the collision prediction ECU 56.

The collision prediction ECU 56 detects positions of individual objects appearing in an image photographed by the camera 58 on the basis of information input from the radar apparatus 60. The collision prediction ECU 56 extracts a feature amount of the individual objects, and discriminates the types (pedestrians/two-wheeled vehicles/other vehicles and the like) of the individual objects on the basis of the extracted feature amount. The collision prediction ECU 56 calculates a probability of collision with the own vehicle for each of the individual objects. The collision prediction ECU 56 transmits a collision prediction signal to a predetermined ECU in the in-vehicle system including the wiper control ECU 38 when the collision prediction ECU 56 detects an object of which probability of collision with the own vehicle is equal to or more than a predetermined value (predicts a collision between the own vehicle and the object).

In the collision prediction signal transmitted by the collision prediction ECU 56, information indicating the type (pedestrians/two-wheeled vehicles/other vehicles and the like) of a collision-predicted object, and information indicating the direction of the collision (a front collision/a left side collision/a right side collision/a rear collision) with the collision-predicted object on the basis of the own vehicle are also included.

Next, as an effect of the present first embodiment, the wiper control processing repeatedly executed by the wiper control ECU 38 when an ignition switch of the own vehicle is turned on is described with reference to FIG. 3.

In Step 100 of the wiper control processing, the control unit 70 of the wiper control ECU 38 determines whether the wiper apparatus 10 is operating. When the contact point of the wiper switch 52 is the stopping position (Off), Step 100 is determined to be negative and the wiper control processing is ended. When the contact point of the wiper switch 52 is other than the stopping position (Off), Step 100 is determined to be positive and transition is made to Step 102.

In Step 102, the control unit 70 determines whether a collision prediction signal is received from the collision prediction ECU 56. When a collision prediction signal is not received from the collision prediction ECU 56, Step 102 is determined to be negative and the processing returns to Step 100 and repeats Steps 100, 102. When a collision prediction signal is received from the collision prediction ECU 56, Step 102 is determined to be positive and transition is made to Step 104.

In Step 104, the control unit 70 determines whether the collision predicted by the collision prediction ECU 56 is a front collision with a person (a pedestrian or a person riding a two-wheeled vehicle) on the basis of the information on the type and the direction of the collision of the collision-predicted object included in the received collision prediction signal. For example, when the collision-predicted object is a vehicle other than a two-wheeled vehicle or the direction of the collision is other than the front collision, a situation in which a person collides with the vehicle and is thrown onto the windshield glass 12 may not occur. Therefore, the processing returns to Step 100 and repeats Step 100 and thereafter when Step 104 is determined to be negative.

Meanwhile, when the collision-predicted object is a pedestrian or a two-wheeled vehicle and the direction of the collision is a front collision, there is a possibility that the person will collide with the vehicle, be thrown onto the windshield glass 12, and directly come into contact with the wipers 14, 20. Therefore, when Step 104 is determined to be positive, transition is made to Step 106, and the operation of the wiper apparatus 10 is switched such that a case in which the person that is thrown onto the windshield glass 12 comes into contact with the wipers 14, 20 is avoided in Step 106 and thereafter.

In other words, in Step 106, the control unit 70 detects the operation direction of the wipers 14, 20 on the basis of the detection signal input from the rotational angle sensor 34. The control unit 70 determines whether the detected operation direction of the wipers 14, 20 is an open direction or a close direction. When the operation direction of the wipers 14, 20 is an open direction, transition is made from Step 106 to Step 108.

In Step 108, the control unit 70 switches the driving of the wiper motor 26 such that the operation direction of the wipers 14, 20 is immediately reversed to the close direction and the operation speed of the wipers 14, 20 in the close direction becomes a speed corresponding to the high-speed operation (Hi). When the operation direction of the wipers 14, 20 is a close direction, transition is made from Step 106 to Step 110. In Step 110, the control unit 70 switches the driving of the wiper motor 26 such that the operation speed of the wipers 14, 20 in the close direction becomes a speed corresponding to the high-speed operation (Hi). As a result, the wiper blades 18, 24 of the wipers 14, 20 can be moved to stopping positions (the lower reverse positions P2 in the present embodiment) in a short amount of time as compared to a case in which the switching of the driving of the wiper motor 26 in Step 108 or Step 110 is not performed.

In following Step 118, the control unit 70 determines whether the wiper blades 18, 24 of the wipers 14, 20 reach predetermined stopping positions (the lower reverse positions P2). When the determination is negative, the determination of Step 118 is repeated until the determination becomes positive, and the driving of the wiper motor 26 is continued during this time. When the wiper blades 18, 24 of the wipers 14, 20 reach the predetermined stopping positions (lower reverse positions P2), Step 118 is determined to be positive and transition is made to Step 120. Then, in Step 120, the control unit 70 stops the operation of the wiper apparatus 10 by stopping the driving of the wiper motor 26, and ends the execution of the wiper control processing.

As above, in the first embodiment, the wiper apparatus 10 reciprocally moves the wipers 14, 20 between the lower reverse positions P2 and the upper reverse positions P1 by reciprocally rotating the rotational shaft of the wiper motor 26. The control unit 70 of the wiper control ECU 38 switches the operation of the wiper apparatus 10 depending on the moving direction of the wipers 14, 20 when it is predicted that the own vehicle will collide with a person during the operation of the wiper apparatus 10. As a result, when it is predicted that the vehicle will collide with a person, the wiper blades 18, 24 of the wipers 14, 20 can be promptly moved to the predetermined stopping positions. Therefore, the possibility of the person that has collided with the vehicle and has been thrown onto the windshield glass 12 directly coming into contact with the wipers 14, 20 can be decreased.

In the first embodiment, the control unit 70 immediately switches the moving direction of the wipers 14, 20 to the close direction when the moving direction of the wipers 14, 20 is an open direction when it is predicted that the own vehicle will collide with a person. As a result, the wiper blades 18, 24 of the wipers 14, 20 can be moved to the predetermined stopping positions in a prompter manner.

In the first embodiment, the wiper apparatus 10 can switch the moving speed of the wipers 14, 20 to any of the plurality of speeds. The control unit 70 switches the moving speed of the wipers 14, 20 to the fastest speed (Hi) out of the plurality of speeds when it is predicted that the own vehicle will collide with a person. As a result, the amount of time it takes until the wiper blades 18, 24 of the wipers 14, 20 reach the predetermined stopping positions can be shortened as compared to a case in which the moving speed of the wipers 14, 20 is not switched.

### Second Embodiment

Next, a second embodiment of the present disclosure is described. The same portions as the first embodiment are denoted by the same reference characters, and description thereof is omitted.

The control unit 70 according to the second embodiment switches the moving speed of the wipers 14, 20 to the maximum speed (hereinafter conveniently referred to as “Max”) that is even faster than the highest speed operation (Hi) out of the plurality of speeds when it is predicted that the own vehicle will collide with a person by the collision prediction ECU 56.

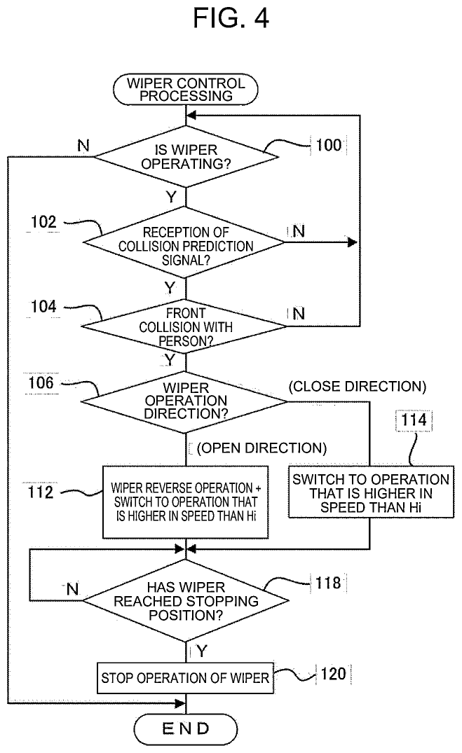

In other words, as shown in FIG. 4, in wiper control processing according to the second embodiment, transition is made from Step 106 to Step 112 when the operation direction of the wipers 14, 20 is an open direction in Step 106. In Step 112, the control unit 70 switches the driving of the wiper motor 26 such that the operation direction of the wipers 14, 20 is immediately reversed to the close direction and the operation speed of the wipers 14, 20 in the close direction becomes the maximum-speed operation (Max) that is even faster than the high-speed operation (Hi).

When the operation direction of the wipers 14, 20 is a close direction in Step 106, transition is made from Step 106 to Step 114. In Step 114, the control unit 70 switches the driving of the wiper motor 26 such that the operation speed of the wipers 14, 20 in the close direction becomes the maximum-speed operation (Max) that is even faster than the high-speed operation (Hi). When the processing of Step 112 or Step 114 is performed, transition is made to Step 118.

The setting of the operation speed of the wipers 14, 20 to the maximum-speed operation (Max) can be realized in Step 112 or Step 114 by causing the duty ratio of on and off of the switching elements of the wiper motor driving circuit 36 to be higher than the high-speed operation (Hi), for example. One example of the duty ratio of on and off of the switching elements for obtaining the maximum-speed operation (Max) is a duty ratio=100%. As a result, the current that flows through the coil of the wiper motor 26 becomes the maximum, and hence the rotation speed of the rotational shaft of the wiper motor 26 becomes the maximum.

As described above, when the operation speed of the wipers 14, 20 is switched to the maximum-speed operation (Max), there is a possibility that the wiper apparatus 10 fails as a result of the current flowing through the coil of the wiper motor 26 becoming a magnitude exceeding a rating. However, control that switches the operation speed of the wipers 14, 20 to the maximum-speed operation (Max) is performed when the own vehicle collides with a person, and the failure of the wiper apparatus 10 is tolerated after the collision because vehicle repair such as replacement of parts will be performed.

As above, in the second embodiment, the control unit 70 switches the moving speed of the wipers 14, 20 to the maximum speed (Max) that is even faster than the highest speed operation (Hi) out of the plurality of speeds when it is predicted that the own vehicle will collide with a person by the collision prediction ECU 56. As a result, the amount of time it takes until the wiper blades 18, 24 of the wipers 14, 20 reach the stopping positions (lower reverse positions P2) can be shortened even more as compared to a case in which the operation speed of the wipers 14, 20 is switched to the high-speed operation (Hi) at the time of prediction of a collision between the own vehicle and a person.

### Third Embodiment

Next, a third embodiment of the present disclosure is described. The same portions as the first embodiment are denoted by the same reference characters, and description thereof is omitted.

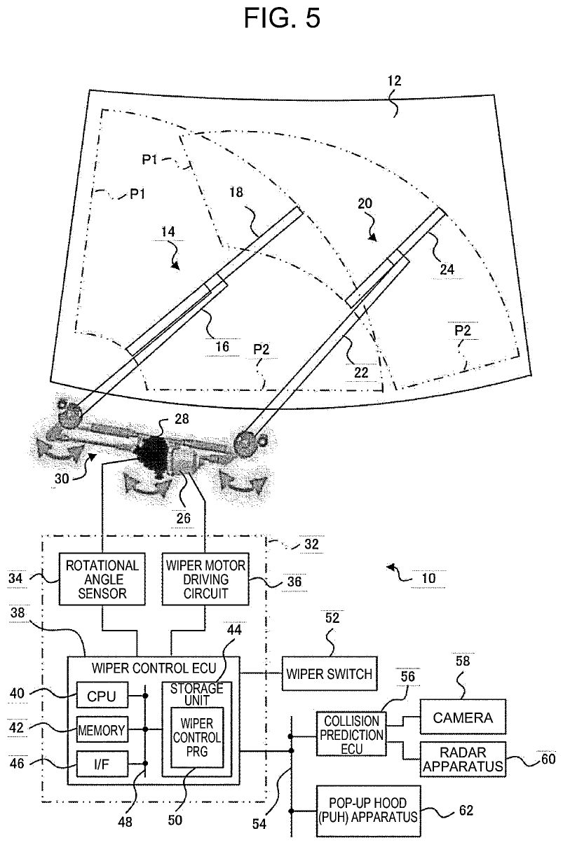

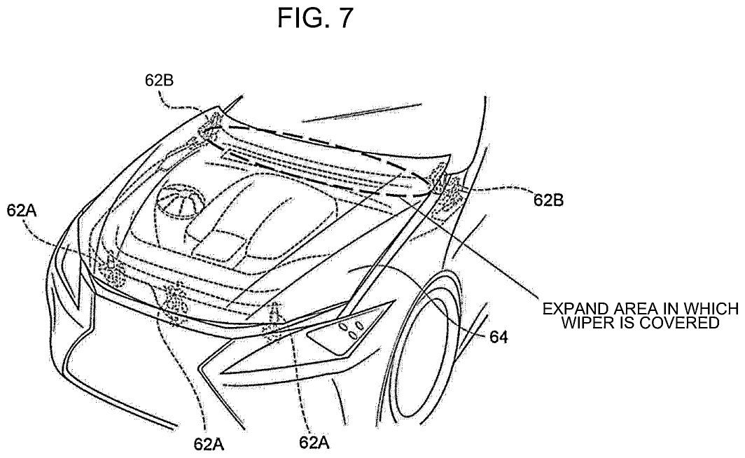

As shown in FIG. 5, a pop-up hood (PUH) apparatus 62 is mounted on a vehicle according to the third embodiment. As shown in FIG. 7, the PUH apparatus 62 includes a first actuator 62A capable of lifting a place near a front end portion of a hood 64 of the vehicle upward, and a second actuator 62B capable of lifting a place near a rear end portion of the hood 64 of the vehicle upward. The PUH apparatus 62 is connected to the system bus 54 of the in-vehicle system and operates in accordance with an operation signal received from the wiper control ECU 38 and the like via the system bus 54. The PUH apparatus 62 may have a configuration in which the first actuator 62A is omitted and only the place near the rear end portion of the hood 64 of the vehicle can be lifted upward by the second actuator 62B.

The control unit 70 according to the third embodiment operates the PUH apparatus 62 when it is predicted that the own vehicle will collide with a person by the collision prediction ECU 56.

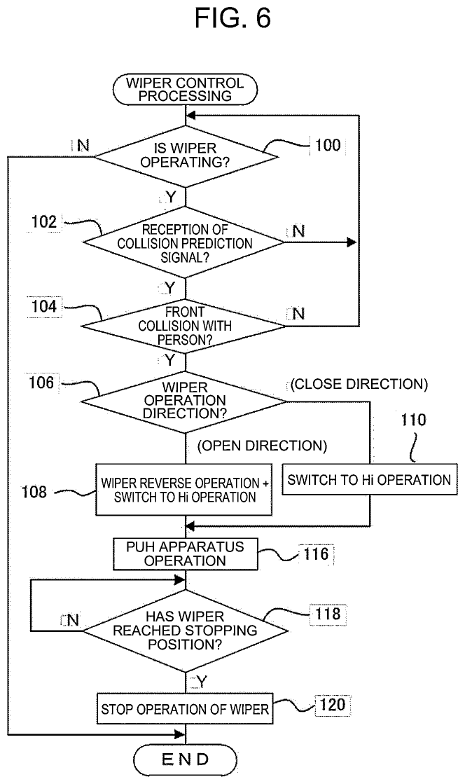

In other words, as shown in FIG. 6, in wiper control processing according to the third embodiment, transition is made to Step 116 after the driving of the wiper motor 26 is switched in Step 108 or Step 110. In Step 116, the control unit 70 operates the PUH apparatus 62 by transmitting an operation signal to the PUH apparatus 62. As a result, as shown in FIG. 7, an area in which the wipers 14, 20 are covered by the rear end portion of the hood 64 is expanded. The degree by which the person that has collided with the vehicle and has been thrown onto the windshield glass 12 sustains an injury by directly coming into contact with the wipers 14, 20 can be decreased.

In the third embodiment, an aspect having a configuration in which the second actuator 62B of the PUH apparatus 62 can lift the place near the rear end portion of the hood 64 of the vehicle has been described, but the present disclosure is not limited thereto. For example, a configuration in which the second actuator 62B of the PUH apparatus 62 lifts the place near the rear end portion of the hood 64 of the vehicle upward and rearward may be employed. As a result, the area in which the wipers 14, 20 are covered by the rear end portion of the hood 64 can be expanded even more, and hence the degree by which the person that has collided with the vehicle and has been thrown onto the windshield glass 12 sustains an injury by directly coming into contact with the wipers 14, 20 can be decreased even more.

In the embodiments described above, an aspect in which a collision prediction signal is autonomically transmitted from the collision prediction ECU 56 at the time of collision prediction and it is determined whether a collision prediction signal is received from the collision prediction ECU 56 in Step 102 in the wiper control processing has been described. However, the present disclosure is not limited to the above. For example, processing of inquiring the collision prediction ECU 56 about whether a collision is predicted by the collision prediction ECU 56 and determining whether a collision is predicted on the basis of the result of the inquiry may be performed instead of the determination of Step 102 described above.

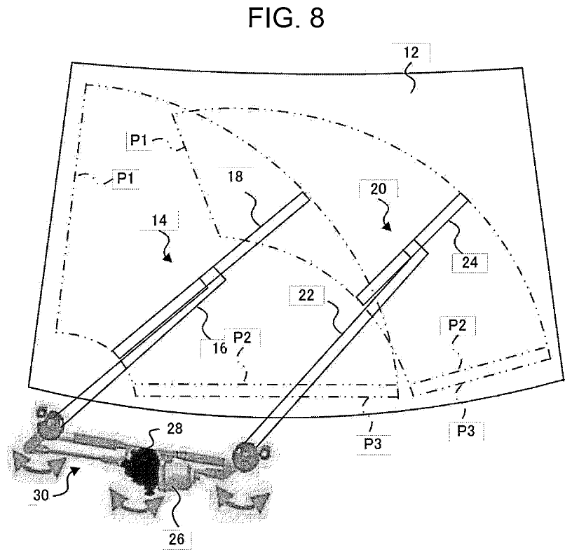

In the embodiments, an aspect in which the lower reverse positions P2 of the wipers 14, 20 is applied as the predetermined stopping positions in the present disclosure has been described, but the present disclosure is not limited thereto. Out of wiper apparatuses having a configuration in which the wipers 14, 20 are reciprocally moved as a result of reciprocally rotating the rotational shaft of the wiper motor 26, there are configurations in which storage positions P3 are provided below the lower reverse positions P2 as shown in FIG. 8 as an example. The wiper apparatus has a configuration of positioning the wiper blades 18, 24 in the storage positions P3 while the wiper apparatus is stopped.

When the present disclosure is applied to a wiper apparatus having such a configuration, the storage positions P3 of the wipers 14, 20 may be applied as the predetermined stopping positions in the present disclosure.

In the embodiments described above, an aspect in which the wiper control program 50 according to the present disclosure is stored (installed) in the storage unit 44 in advance has been described, but the present disclosure is not limited thereto. For example, the wiper control program 50 can also be provided in a form of being recorded on a non-transitory storage medium such as an HDD, an SSD, and a DVD.

What is claimed is:

1. A wiper control apparatus for a wiper apparatus of a vehicle, the wiper apparatus reciprocally moving a wiper between a lower reverse position and an upper reverse position by reciprocally rotating a rotational shaft of a wiper motor, the wiper control apparatus comprising a processor configured to control operation of the wiper, wherein
the processor is configured to switch operation of the wiper depending on a moving direction of the wiper when the processor receives a notification of prediction that the vehicle will collide with a person while the wiper is operating.

2. The wiper control apparatus according to claim 1, wherein the processor is configured to immediately switch the moving direction of the wiper to a close direction when the processor receives the notification and the moving direction of the wiper is an open direction.

3. The wiper control apparatus according to claim 2, wherein the processor is configured to:
switch a moving speed of the wiper to one of speeds; and
switch the moving speed of the wiper to a fastest speed out of the speeds when the processor receives the notification.

4. The wiper control apparatus according to claim 2, wherein the processor is configured to:
switch a moving speed of the wiper to one of speeds; and
switch the moving speed of the wiper to a speed that is even faster than a fastest speed out of the speeds when the processor receives the notification.

5. The wiper control apparatus according to claim 2, wherein the processor is configured to operate a pop-up hood apparatus that lifts an end portion of a hood of the vehicle when the processor receives the notification.

6. A wiper apparatus for a vehicle, comprising:
a wiper;
a wiper motor having a rotational shaft; and
a processor configured to control operation of the wiper, wherein
the wiper motor is configured to reciprocally rotate the rotational shaft to reciprocally move the wiper between a lower reverse position and an upper reverse position, and
the processor is configured to switch operation of the wiper depending on a moving direction of the wiper when the processor receives a notification of prediction that the vehicle will collide with a person while the wiper is operating.

7. The wiper apparatus according to claim 6, wherein the processor is configured to immediately switch the moving direction of the wiper to a close direction when the processor receives the notification and the moving direction of the wiper is an open direction.

8. The wiper apparatus according to claim 7, wherein the processor is configured to:
switch a moving speed of the wiper to one of speeds; and
switch the moving speed of the wiper to a fastest speed out of the speeds when the processor receives the notification.

9. The wiper apparatus according to claim 7, wherein the processor is configured to:
switch a moving speed of the wiper to one of speeds; and
switch the moving speed of the wiper to a speed that is even faster than a fastest speed out of the speeds when the processor receives the notification.

10. The wiper apparatus according to claim 7, wherein the processor is configured to operate a pop-up hood apparatus that lifts an end portion of a hood of the vehicle when the processor receives the notification.
